(19) United States
(12) Patent Application Publication
(10) Pub. No.: US 2026/0264047 A1
(43) Pub. Date: Sep. 10, 2026

(54) POROUS MONOLITHIC POLYMER FOR SEPARATION AND PURIFICATION OF BIOLOGICAL PARTICLES, METHOD FOR PRODUCTION OF POROUS MONOLITHIC POLYMER FOR SEPARATION AND PURIFICATION OF BIOLOGICAL PARTICLES, AND METHOD FOR SEPARATION AND PURIFICATION OF BIOLOGICAL PARTICLES COMPOSED OF PHOSPHOLIPIDS USING POROUS MONOLITHIC POLYMER FOR SEPARATION AND PURIFICATION OF BIOLOGICAL PARTICLES

(71) Applicants: Tetsuya TANIGAWA, Osaka (JP); KYOTO UNIVERSITY, Kyoto (JP); GLORY INDUSTRY CO., LTD., Osaka (JP)

(72) Inventors: Takuya KUBO, Kyoto (JP); Eisuke KANAO, Kyoto (JP); Yasushi ISHIHAMA, Kyoto (JP); Yoshitomo TANAKA, Osaka (JP); Tetsuya TANIGAWA, Osaka (JP)

(21) Appl. No.: 18/838,912

(22) PCT Filed: Sep. 4, 2023
(86) PCT No.: PCT/JP2023/032249

§ 371 Date: May 18, 2026

(51) Int. Cl. B01J 20/26; B01J 20/02; B01J 20/28; B01J 20/30

(52) U.S. Cl. CPC B01J 20/264; B01J 20/0211; B01J 20/268; B01J 20/28052; B01J 20/3007; B01J 20/3014; B01J 20/3071; B01J 20/3092; B01J 2220/4806; B01J 2220/4812; B01J 2220/58

(57) ABSTRACT

The problem to be solved is to provide a porous monolithic polymer for separation and purification of biological particles that can be used to efficiently and quickly purify EVs, a method for production thereof, and a method for separation and purification of biological particles composed of phospholipids using the monolithic polymer for separation and purification of biological particles.

The present invention is related to a porous monolithic polymer for separation and purification of biological particles, obtained by hybridization of an olefin-based thermoplastic resin and an inorganic oxide; a method for production thereof; and a method for separation and purification of biological particles having phospholipid on the surface using the porous monolithic polymer for separation and purification of biological particles.

### FIELD OF THE INVENTION

The present invention relates to a porous monolithic polymer for separation and purification of biological particles, which is a kneaded product of polymer and inorganic oxide, particularly TIO2; a method for production of the polymer; and a method for separation and purification of biological particles composed of phospholipids.

### BACKGROUND OF THE INVENTION

Extracellular vesicles (EVs) are nano-sized membranous particles released from all types of cells and present in various bodily fluids, including blood, urine, and saliva. Especially, small-EVs (SEVs), which are the particles with approximately 100 nm diameter, contain various biomolecules, such as proteins, lipids, and nucleic acids, and reflect physiological and pathological conditions of donor cells. Not only does this characteristic make SEVs highly desirable as noninvasive biomarkers utilizing bodily fluids, but also SEVs have attracted attention in the drug discovery industry as a promising tool for drug delivery due to their abilities such as crossing biological barriers and delivering their cargo to target cells. Numerous studies actually have demonstrated the potential of SEVs having therapeutic cargo for treating various diseases, including cancers, neurodegenerative disorders, and infectious diseases.

Nevertheless, researchers have not yet achieved the optimal approach to collect SEVs. The gold-standard method of SEV purification is ultracentrifugation (UC), which can purify SEVs from cell debris and contaminant proteins based on different densities or sizes. However, UC requires complex procedures and long processing time, resulting in low recovery rates and limited throughput. As an alternative, immuno-affinity based on membrane markers can be utilized to collect SEVs with high purity. However, immuno-affinity methods are not feasible regarding large-volume samples since biological ligands are costly, and can only operate with a limited amount. Another drawback is that the molecular population of SEVs is heterogeneous, leading to a risk of missing a specific population of SEVs having the target molecule. While other methods, such as polymer precipitation, size exclusion chromatography, microfluidic chips, and flow field-flow fractionation have been developed, there are problems such as protein contamination, complex procedures, limited to small-scale experiments, and requiring sophisticated equipment. Therefore, an efficient and rapid purification method for SEVs, which can be commonly applied to a wide range of biological samples, is necessary for accelerating the clinical application and the development of the drug industry.

For example, the invention described in Japanese Unexamined Patent Application Publication No. 2016-070937 proposes a granular porous material for use in a liquid chromatography column for separating biological molecules such as peptides, proteins, or nucleic acids. However, the invention of the above cited document is limited to small-scale operations since the preparation of porous materials is time-consuming and labor-intensive, separation and purification also take time, and the amount of sample that can be loaded at a time is limited.

The invention described in International Publication No. WO2020/080387 proposes a method for separating and recovering the extracellular vesicles from a sample in the presence of a polymer. However, the method is nothing more than improving the separation accuracy of the conventional separation and purification method for extracellular vesicles by adding a water-soluble polymer to the sample.

### SUMMARY OF THE INVENTION

### Problems to be Solved by the Invention

The present invention aims to provide a porous monolithic polymer for separation and purification of biological particles that can be used to efficiently and quickly purify EVs, a method for production thereof, and a method for separation and purification of biological particles composed of phospholipids using the monolithic polymer for separation and purification of biological particles.

Here, “monolith” refers to a functional material that is a mass of porous material having skeletons and voids that are each continuous and can be applied as an immobilization carrier for columns and catalysts based on its structural characteristics.

The inventors, in their intensive study to solve the above-mentioned problems of the conventional arts, found that a spongy monolithic polymer (SPM), a kneaded product of olefin-based thermoplastic resin and inorganic oxide, provides a simple, rapid, and highly efficient purification method for extracellular vesicles (EVs). Surprisingly, this method can purify 130.1 times small EVs from the same amount of cell culture medium compared to ultracentrifugation, within 1 h with minimal steps. Furthermore, the flexibility for shape and size of the material enables its application to small volume of clinical samples as well as large volumes of bovine serum. The SPM hybridized with inorganic oxide according to the present invention will be a universal platform for collecting and purifying SEVs and significantly contribute to drug discovery research and biomarker exploration using EVs.

### Means for Solving the Problems

The invention according to a first aspect is a porous monolithic polymer for separation and purification of biological particles, obtained by hybridization of an olefin-based thermoplastic resin and an inorganic oxide.

The invention according to a second aspect may be the porous monolithic polymer for separation and purification of biological particles according to the first aspect, wherein the thermoplastic resin is one or more selected from the group consisting of poly(ethylene-co-glycidyl methacrylate) (PEGM), ethylene-vinyl acetate copolymer, high-density polyethylene, low-density polyethylene, olefin-based elastomer, and polyamide-based elastomer.

The invention according to a third aspect may be the porous monolithic polymer for separation and purification of biological particles according to the first aspect, wherein the inorganic oxide is one or more selected from the group consisting of titanium oxide, magnesium oxide, aluminum oxide, silicon dioxide, and calcium phosphate.

The invention according to a fourth aspect relates to the porous monolithic polymer for separation and purification of biological particles according to the first aspect, wherein a porosity is 50% to 90%, a pore size is 1 μm to 200 μm, and a melting point is 60° C. to 180° C.

The invention according to a fifth aspect is a method for production of the porous monolithic polymer for separation and purification of biological particles according to the first aspect comprising: melting the thermoplastic resin;
kneading the inorganic oxide into the thermoplastic resin together with a pore template and an auxiliary of pore template; and
eluting the pore template with an aqueous solvent after molding.

The invention according to a sixth aspect may be the method for production according to the fifth aspect, wherein the pore template is an organic substance or an inorganic substance which does not react with the thermoplastic resin and the inorganic oxide during the kneading.

The invention according to a seventh aspect may be the method for production according to the sixth aspect, wherein the pore template is one or more selected from the group consisting of pentaerythritol, corn starch, sodium sulfate anhydrous, starch such as wheat starch and potato starch, artificial sweeteners such as aspartame and saccharin, polysaccharide such as hemicellulose, acid-soluble inorganic compounds such as calcium carbonate and magnesium carbonate, and salt.

The invention according to an eighth aspect may be the method for production according to the fifth aspect, wherein the pore template has a particle size between 1 μm to 200 μm.

The invention according to a ninth aspect may be the method for production according to the fifth aspect, wherein the auxiliary of pore template is a monomer or polymer of polyhydric alcohol.

The invention according to a tenth aspect may be the method for production according to the ninth aspect, wherein the auxiliary of pore template is one or more selected from the group consisting of polyalkylene glycol and diethylene glycol, such as (poly(oxyethylene-oxypropylene)) triol and polyethylene glycol.

The invention according to an eleventh aspect relates to a method for separation and purification of biological particles having phospholipid on the surface by the porous monolithic polymer for separation and purification of biological particles according to the first aspect.

The invention according to a twelfth aspect may be the method according to the eleventh aspect, wherein the biological particles are extracellular vesicles.

### Effects of the Invention

According to the invention of the first aspect, a porous monolithic polymer that is a kneaded product of thermoplastic resin and inorganic oxide can be used for separation and purification of biological particles.

According to the invention of the second aspect, the porous monolithic polymer for separation and purification of biological particles can be obtained from easily available materials.

According to the invention of the third aspect, the porous monolithic polymer for separation and purification of biological particles can be obtained from easily available materials.

According to the invention of the fourth aspect, the porous monolithic polymer for separation and purification of biological particles which is a new and superior medium used for separation and purification of biological particles can be obtained from easily available materials.

According to the invention of the fifth aspect, the porous monolithic polymer can be produced with pore size and porosity adjusted optionally.

According to the invention of the sixth aspect, the pore template can be selected from a wide range of options when producing the porous monolithic polymer.

According to the invention of the seventh aspect, the porous monolithic polymer can be produced using easily available materials to form pores.

According to the invention of the eighth aspect, the porous monolithic polymer can be produced with pores of 1 μm to 200 μm, thereby facilitating the capture of biological particles.

According to the invention of the ninth aspect, the porous monolithic polymer can be produced using an easily available auxiliary of pore template.

According to the invention of the tenth aspect, the porous monolithic polymer can be produced using an easily available auxiliary of pore template.

According to the invention of the eleventh aspect, the porous monolithic polymer for separation and purification of biological particles of the present invention adsorbs the phospholipids of biological particles, thereby facilitating the separation and purification of biological particles.

According to the invention of the twelfth aspect, the porous monolithic polymer for separation and purification of biological particles of the present invention adsorbs the phospholipids of extracellular vesicles, thereby facilitating the separation and purification of extracellular vesicles.

### BRIEF DESCRIPTION OF DRAWINGS

FIG. 1a is an SEM image of SPM and TIO2-SPM according to an embodiment of the present invention.

FIG. 1b shows the pore characteristics of TIO2-SPM according to an embodiment of the present invention, which are measured by a mercury porosimeter.

FIG. 1c shows the LNP-adsorption capacity of TiO2-SPM column according to an embodiment of the present invention.

FIG. 1d shows the number of LNPs separated and purified in each fraction by TiO2-SPM column according to an embodiment of the present invention.

FIG. 2a-2c show the particle size profiles of LNPs in loaded sample and the elution rate of TiO2-SPM, according to an embodiment of the present invention. FIG. 2a is the lipid components of the prepared LNPs.

FIG. 2a-2c show the particle size profiles of LNPs in loaded sample and the elution rate of TiO2-SPM, according to an embodiment of the present invention. FIG. 2b is the dynamic light scattering raw distribution curve of the nanoparticles in the loaded sample.

FIG. 2a-2c show the particle size profiles of LNPs in loaded sample and the elution rate of TiO2-SPM, according to an embodiment of the present invention. FIG. 2c is the size distribution of the LNPs in the elution fraction determined by nano tracking analysis.

FIG. 3a shows the number of NPs in elution fractions from protein-immobilized TiO2-SPM according to an embodiment of the present invention. Proteins were immobilized for suppression of non-specific adsorption. Each centrifugation was carried out at 1000×g for 1 min.

FIG. 3b shows the number of NPs in elution fractions at different loading centrifugation speeds when protein-immobilized TIO2-SPM according to an embodiment of the present invention is used.

FIG. 4a shows the number of NPs collected from culture supernatant by SEV purification according to an embodiment of the present invention. (Right) The number of NPs collected by UC from 38.5 ml of culture supernatant and the number of NPs collected with TiO2-BSA-SPM from 0.4 mL of culture supernatant. (Left) Equivalent values for 1 ml of culture supernatant.

FIG. 4b is the particle size profiling of NPs collected with TIO2-BSA-SPM and NPs collected by UC.

FIG. 4c is a transmission electron microscopy image of NPs collected with TiO2-BSA-SPM.

FIG. 4d shows the single particle analysis by an imaging flow cytometry of EVs collected with TIO2-BSA-SPM and stained for lipid membranes.

FIG. 4e shows the single particle analysis of particles which was treated with Triton-X.

FIG. 4f shows the overlapping proteins quantified in NPs collected with TIO2-BSA-SPM and by UC.

FIG. 4g shows the top five items of cell components from GO enrichment analysis of only identified proteins in NPs collected with TIO2-BSA-SPM.

FIG. 4h shows the top five items of cell components from GO enrichment analysis of only identified proteins in NPs collected by UC.

FIG. 5a shows the characteristics of EV-depleted FBS prepared with syringe barrel type TIO2-BSA-SPM. FIG. 5a shows the particle size profiling of NPs of FBS and EV-depleted FBS which are prepared with TIO2-BSA-SPM and by UC.

FIG. 5b shows the number of NPs in EV-depleted FBS.

FIG. 5c shows images of HEK293T cells cultured in EV-depleted FBS prepared with TIO2-BSA-SPM (right) and by UC (left).

FIG. 5d shows the number of living cells cultured in Dulbecco's Modified Eagle Medium (Thermo Fisher Scientific) containing 10% EV-depleted FBS (living cells were counted by automated cell counter (LUNA-FLTM, Logos Biosystems)).

FIG. 6a shows the gating strategies for single-particle analysis of SEVs collected with TiO2-BSA-SPM. The gating is for distinguishing flow control beads. “Speed Beads” is the region indicating flow control beads, and “Region 1” is the region indicating sample-derived objects. The vertical axis indicates the side scatter intensity, and the horizontal axis indicates the bright field area of the object.

FIG. 6b shows the gating strategies for single-particle analysis of SEVs collected with TIO2-BSA-SPM. The gating is for removing aggregates from the particles detected in Region 1. The vertical axis plots the area of the side scatter image, and the horizontal axis plots the intensity of the side scatter.

FIG. 7a shows the characteristics of NPs collected with TiO2-BSA-SPM from a healthy donor's serum sample. FIG. 7a shows the size distribution of the collected NPs from the serum sample.

FIG. 7b shows the characteristics of NPs collected with TiO2-BSA-SPM from a healthy donor's serum sample. FIG. 7b shows the overlapping of proteins quantified in the serum sample and NPs. Proteome analyses were performed three times using independent experiments with technical repeats.

FIG. 7c shows the characteristics of NPs collected with TiO2-BSA-SPM from a healthy donor's serum sample. FIG. 7c shows the top five items in cell components from GO enrichment analysis of only identified proteins in NPs.

### DETAILED DESCRIPTION OF THE INVENTION

Embodiments of the porous monolithic polymer for separation and purification of biological particles, the method for production thereof, and the method for separation and purification of biological particles composed of phospholipids using the porous monolithic polymer for separation and purification of biological particles according to the present invention are described below with reference to the drawings.

The porous monolithic polymer for separation and purification of biological particles of the present invention is a kneaded product of an olefin-based thermoplastic resin and an inorganic oxide. By kneading the thermoplastic resin with the inorganic oxide, the inorganic oxide is hybridized with the thermoplastic resin.

Examples of the thermoplastic resins used in the present invention can include flexible and inexpensive polymers, such as poly(ethylene-co-glycidyl methacrylate) (PEGM), ethylene-vinyl acetate copolymer, high-density polyethylene, low-density polyethylene, olefin-based elastomer, and polyamide-based elastomer. A combination of two or more of these thermoplastic resins can also be used. The spongy monolithic polymer (SPM) obtained herein is applicable to separation media of various shapes and sizes.

Preferred examples of the inorganic oxide used in the present invention include metal oxides such as titanium oxide, aluminum oxide, and magnesium oxide; and inorganic oxides such as silica (silicon dioxide), in particular fumed silica, and calcium phosphate, in particular tricalcium phosphate. A combination of two or more of inorganic oxides can also be used.

The spongy monolithic polymer (SPM) of the present invention has pores of a pore size of 1 μm to 200 μm with the porosity of 50% to 90%. Pore size smaller than 1 μm leads to clogging, and pore size larger than 200 μm fails to capture the biological particles and causes washout of them. Porosity less than 50% increases the time and labor required for separation and purification, and porosity greater than 90% makes the SPM brittle and unsuitable for separation and purification. More preferably, the spongy monolithic polymer has pores of a pore size of 5 μm to 10 μm with a porosity of 70% to 80%. This pore size is much larger than the diameter of about 100 nm of particularly small particles (SEVs) among extracellular vesicles (EVs), thereby providing a flow path suitable for low-pressure chromatographic separation of SEVs without clogging.

The TiO2-hybridized SPM of the present invention selectively captures the phosphate groups abundantly existing on the lipid bilayer surface of SEVs via bidentate binding. This bidentate binding is pH-responsive and reversible, capturing SEVs under neutral conditions and releasing them under basic conditions (pH 10-12).

When hybridized with silica, the SPM of the present invention selectively captures the basic amino acid residues of SEVs. Furthermore, when hybridized with calcium phosphate, the SPM can capture phosphate groups and hydroxy groups.

For the SPM of the present invention, when the inorganic oxide is kneaded into the thermoplastic resin, a pore template and an auxiliary of pore template may be kneaded together into them. The SPM of the present invention is obtained by homogeneously kneading 1 to 20% by weight of inorganic oxide, 50 to 80% by weight of pore template, and 7 to 15% by weight of auxiliary of pore template into 15 to 35% by weight of thermoplastic resin melted at 60° C. to 180° C., then eluting the pore template with an aqueous solvent after molding.

The thermoplastic resin loses fluidity at temperatures lower than 80° C. and cannot maintain its shape at temperatures higher than 180° C. Furthermore, the thermoplastic resin of less than 15% by weight will be compressed by liquid pressure during liquid feeding, thereby resulting in the significantly deteriorated liquid permeability; and the thermoplastic resin of more than 35% by weight will result in the deteriorated liquid permeability due to its lower porosity, and will drop the capture ability of SEVs due to reduced surface area inside the sponge.

The inorganic oxide of less than 1% by weight will make the amount of biological particles, which can be captured, become too small; the inorganic oxide of more than 20% by weight will deteriorate the efficiency of hybridization with thermoplastic resin, thereby increasing detachment of inorganic oxides from the thermoplastic resin during the step of eluting pore template with aqueous solvents after molding, and making the detached inorganic oxides wasted.

The pore template of less than 50% by weight will result in the deteriorated liquid permeability due to its densification; the pore template of more than 80% by weight will destroy the shape of the resin.

The auxiliary of pore template of less than 7% by weight will deteriorate the liquid permeability between pores; and the auxiliary of pore template of more than 15% by weight will make the surface area inside the sponge become too small.

These weight ratios depend on the balancing for providing the SPM of the present invention with the ability of separation and purification of biological particles.

The pore template is prepared with a particle size of 1 to 200 μm. This particle size is to prepare the SPM with a pore size of 1 to 200 μm, more preferably with a particle size of 1 to 10 μm. Substances with hairy particles that is not dissolved in thermoplastic resin are used. Preferably, pentaerythritol, corn starch, starch such as wheat starch and potato starch, sugar, polysaccharide such as hemicellulose, as well as tetramethylolmethane indicated by the following Formula 1 (Compound 1) (Chemical name; 2.2-dihydroxymethyl-1.3-propanediol), or the like are used.

The auxiliary of pore template is used to shorten the time for elution of the pore template into water. Such auxiliary is preferably that having a high boiling point, being able to improve the fluidity of the resin in a small amount, and, having a small loss on heat exposure. Polyalkylene glycol, diethylene glycol, or the like, such as (poly(oxyethylene-oxypropylene)) triol and polyethylene glycol, are preferably used.

The separation and purification of biological particles of the present invention are performed by packing the SPM into a column and loading the sample. The column used herein includes, but not limited to, a spin column or a syringe barrel column etc. The spin column is suitable for centrifugation, and the syringe barrel type is suitable for separation by pressure.

When biological particles with phospholipids adsorbed by hybridized inorganic oxide enter the pores of the SPM, the separation and purification of biological particles according to the present invention is enabled.

The SEV purification platform according to the present invention was developed by hybridizing TiO2 particles with a spongy polymer (SPM). TIO2-SPM is molded into solid-phase extraction columns that are effective in collecting SEVs from various biological samples via bidentate binding to the embedded TiO2. The large through-pores due to the spongy structure of the polymer enables simple flow-through treatment by centrifugation, or manual pressure for 1 min. This method, including pretreatment, can be completed within 1 h, and collect SEVs 130.7 times or more from the same volume of cell culture supernatant when compared with UC. Shotgun proteome analysis also demonstrated that SEVs collected with TIO2-SPM were more comprehensive than that collected by UC. This method can be applied to clinical samples, and achieve efficient collecting of SEVs from 100 μL of plasma samples. Furthermore, modifying the format into a syringe barrel type will increase the adsorption capacity and sample loading volume, thereby enabling the complete removal of EVs from 10 ml of FBS (fetal bovine serum). TiO2-SPM according to the present invention will be a universal platform for collecting and purifying SEVs, and can significantly contribute to drug discovery research and biomarker exploration using SEVs.

### EXAMPLES

The monolithic polymers for biological separation of the present invention are described below with examples, but the invention is not limited to these examples.

### Example 1

### <Preparation of TiO2-SPM>

35 wt % of poly(ethylene-co-glycidyl methacrylate) (PEGM) (containing 12% glycidyl methacrylate), 52 wt % of pore template (pentaerythritol) (with particle size in diameter classified as about 10 μm), 7 wt % of auxiliary of pore template (poly(oxyethylene-oxypropylene)) triol, and 20 wt % of TiO2 particles were melted at 150° C. and homogeneously kneaded.

The resulting material was extruded into a columnar shape at 130° C.

The column-like material was immediately cooled in water to obtain a stick-like material.

Then, the stick-like materials were washed with methanol and water using ultrasonication to remove soluble compounds.

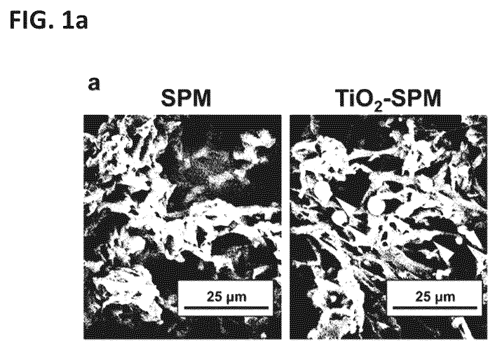

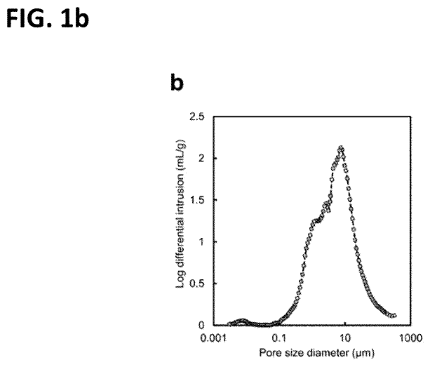

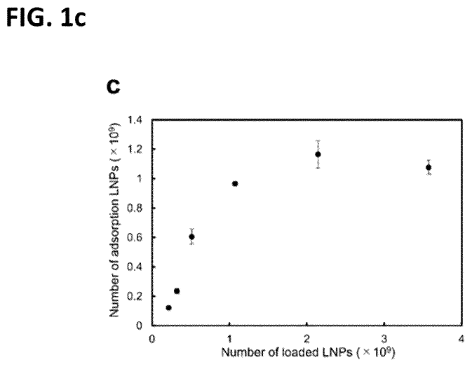

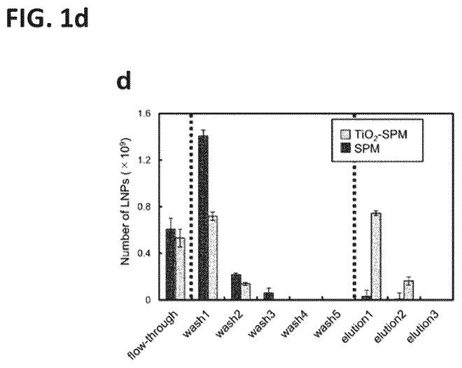

The porosity of the resulting TiO2-hybridized spongy monolithic polymer (TIO2-SPM) was about 75 %, and the cross-sectional diameter across the overall length of the TiO2-SPM was 8.0 mm. Furthermore, morphology observation of the TiO2-SPM was performed using a field-emission scanning electron microscope (JSM6700-M, JEOL, Tokyo, Japan; hereinafter, SEM). The image of the prepared TiO2-SPM by the above SEM shows that TiO2 particles were properly hybridized with SPM by being kneaded and exposed on the surface (FIG. 1). The median pore size of TiO2-SPM characterized by mercury porosimeter was 5.21 μm. The pore was much larger than the size of SEVs (FIG. 1b).

### <Preparation of Column>

Then, the stick-like TiO2-SPM was sliced into 1 cm-thick rounds to obtain TiO2-SPM disks.

To prepare a TiO2-SPM packed solid phase extraction (SPE) column, two types of empty polypropylene cartridges were used (spin column (2 cm×7.0 mm i.d.) and syringe barrel columns (5 cm×7.0 mm i.d.)) based on the target application and sample volume. The spin column type is suitable for centrifugation, and the syringe barrel type is suitable for SPE using manual pressure. In the syringe barrel type, multiple TiO2-SPM disks can be packed to increase the adsorption capacity of EVs (maximum 5 disks). The diameter of the TiO2-SPM disk (8.0 mm) was larger than the inner diameter of the empty cartridges. Nevertheless, the elasticity of the spongy monolith material facilitated packing. The packing procedure is simple. TiO2-SPM disks were immersed in methanol and thoroughly wetted, then a disk was set parallelly on the top of the cartridge and straightly shoved into the bottom using a stainless-steel rod. The disks need to be carefully shoved to prevent distorting or wrinkling inside the cartridge during the process. Then, the prepared column was washed with methanol/water=1/1 solution of which volume was five-fold of the packed TIO2-SPM, to remove pore template and homogenize the packing state.

### <Separation Behavior of Liposomal Nanoparticle in TiO2-SPM>

To evaluate the adsorption capacity of TiO2-SPM, liposomal nanoparticle (LNP) solution (0.4 mL) of different concentrations was prepared and loaded into the TiO2-SPM which was packed in a spin column. Due to the high permeability derived from the spongy morphology, the sample loading process was rapidly completed by centrifugation at 1000×g for 1 min. After collecting a flow-through fraction, the spin column was washed with phosphate buffered salts (PBS) (0.4 ml×5, wash fraction).

The amount of adsorbed LNPs on the TiO2-SPM column was estimated by subtracting the sum of the flow-through fraction and the wash fraction from the initial amount of loaded LNPs (FIG. 1c).

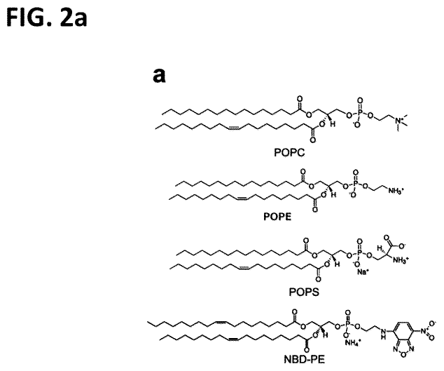

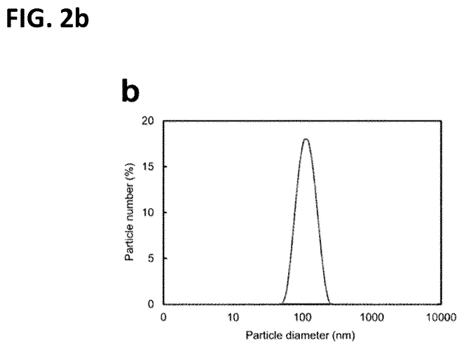

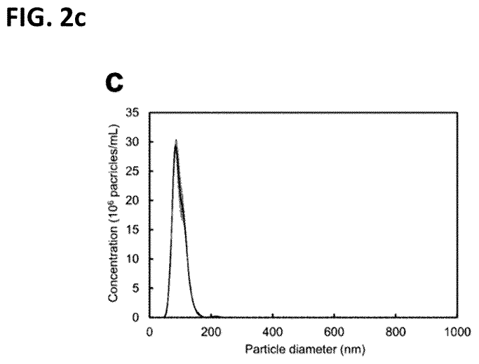

The result showed that the number of adsorbed LNPs increased with the loaded LNPs, and the maximum adsorption capacity was determined to be 1.17×1010 particles. Then elution of the adsorbed particles from TiO2-SPM was also attempted. According to previous reports, high pH conditions can effectively disrupt the binate bindings of TiO2 particles to the phosphate groups on SEV surfaces ((a) F. Gao, F. Jiao, C. Xia, Y. Zhao, W. Ying, Y. Xie, X. Guan, M. Tao, Y. Zhang, W. Qin, X. Qian, Chem. Sci. 2019, 10, 1579; (b) X. Xiang, F. Guan, F. Jiao, H. Li, W. Zhang, Y. Zhang, W. Qin, Anal. Method 2021, 13, 1591.). Therefore, 10% NH3·H2O was used as the elution solvent. The collected elution fractions were quickly substituted with PBS by ultrafiltration (30 kDa MWCO, Amicon®) to protect the lipid bilayer from a high pH condition. As shown in FIG. 1d, the adsorbed LNPs were promptly eluted under the high pH condition, and 9.07×109 LNPs (84.6% of the adsorbed LNPs) were contained in the elution fraction. The average diameter of LNPs in the elution fraction was 97 nm, similar size to the previous loading (FIG. 2c). The adsorption ability was not observed in normal SPM, demonstrating the effective bidentate binding between the phosphate groups on the LNP surfaces and the hybridized TiO2. Strong affinity between TIO2-SPM and LNPs was confirmed.

### Example 2

### <Purification of SEVs Contained in Biological Samples>

Then, the SEVs were purified and collected by ultracentrifugation from the supernatant of the cell culture medium of human embryonic kidney cell line HEK293T (RIKEN BRC) utilizing a TiO2-SPM column.

The cell culture was performed in Dulbecco's Modified Eagle Medium (DMEM, Thermo Fisher Scientific) containing 10% fetal bovine serum (FBS, Thermo Fisher Scientific) at 37° C. with 5% CO2; the cells were grown until approximately 70-80% confluent and then cultured in EV-depleted medium for 48 h.

The supernatant was prepared from cells at approximately 70-80% confluence, then centrifuged at 4° C. at 400×g for 10 min and 2000×g for 10 min to remove cell debris and large EVs, respectively.

0.4 mL of the prepared supernatant was loaded into the TiO2-SPM spin column, and the column was treated in the same way as Example 1.

The result of nanoparticle tracking analysis (NTA) showed that 1.45×108 nanoparticles (NPs) were observed in the elution fraction, implying successful collection of SEVs with TIO2-SPM (FIG. 2a, left bar).

However, the number of NPs collected from the culture supernatant here was much less than the number of LNPs that was expected.

Membrane proteins such as CD9 and CD81 are present on the surface of SEVs and may adsorb non-specifically to the hydrophobic surface of TiO2-SPM (E. G. Evtushenko, D. V. Bagrov, V. N. Lazarev, M. A. Livshits, E. Khomyakova, Plos One 2021, 15, e0243738.; E. Kanao, S. Wada, H. Nishida, T. Kubo, T. Tanigawa, K. Imami, A. Shimoda, K. Umezaki, Y. Sasaki, K. Akiyoshi, J. Adachi, K. Otsuka, Y. Ishihama, Anal. Chem. 2022, 94, 18025.).

Furthermore, due to competing interactions with other substances in a supernatant of a mixed culture, the adsorption time of hybridized TIO2 towards SEVs might become longer than that towards LNPs.

There have been reported that incubation times have become five folds until sufficient binding between SEVs in urine and TIO2 particles is confirmed (F. Gao, F. Jiao, C. Xia, Y. Zhao, W. Ying, Y. Xie, X. Guan, M. Tao, Y. Zhang, W. Qin, X. Qian, Chem. Sci. 2019, 10, 1579.).

### Example 3

### <Immobilization of Proteins>

To improve the efficiency of collecting NPs from the culture supernatant, the inventors immobilized proteins (bovine serum albumin) on the surface of TiO2-SPM to improve the hydrophilicity of the surface, and slowed down the centrifugation speed. Proteins can be easily immobilized on TIO2-SPM via the epoxy group on the surface of the TiO2-SPM by incubating at 37° C.

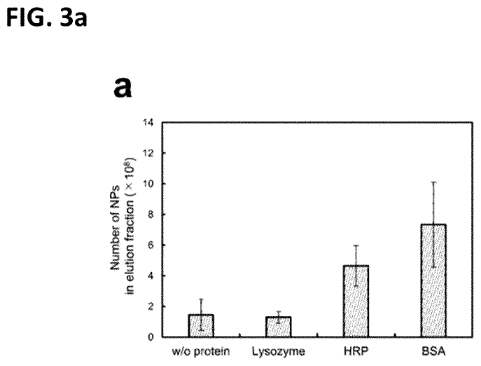

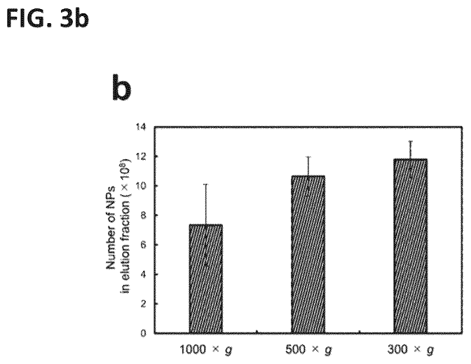

7.34×108 nanoparticles were confirmed in the elution fraction of the TIO2-SPM immobilized with BSA (TIO2-BSA-SPM), indicating that the improved hydrophilicity significantly reduced non-specific adsorption (FIG. 3a). The centrifugation speed during sample loading was optimized at 300×g, and 1.17×109 nanoparticles were collected (FIG. 3b). The centrifugation process was also completed within 1 min, but the loaded supernatant did not pass through at lower than 300×g.

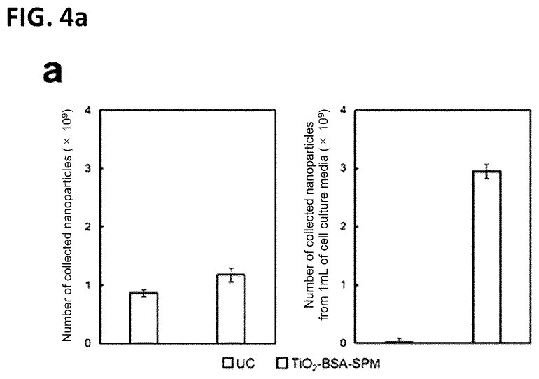

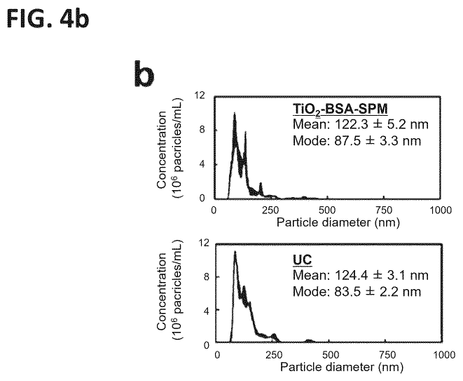

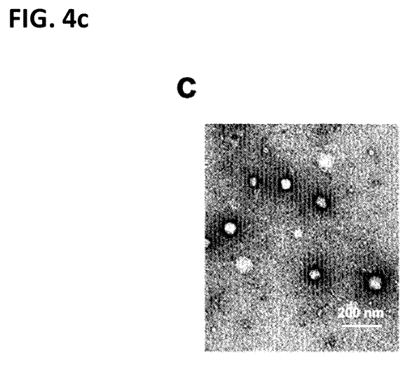

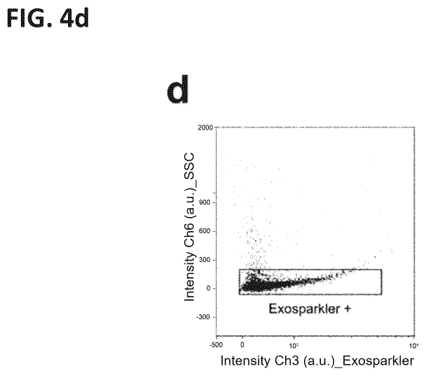

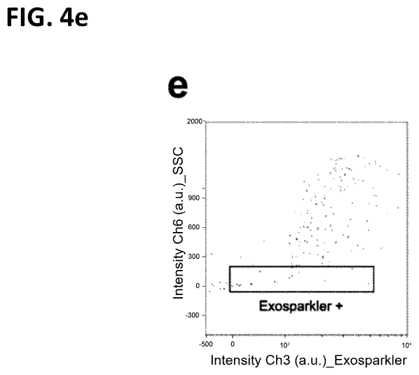

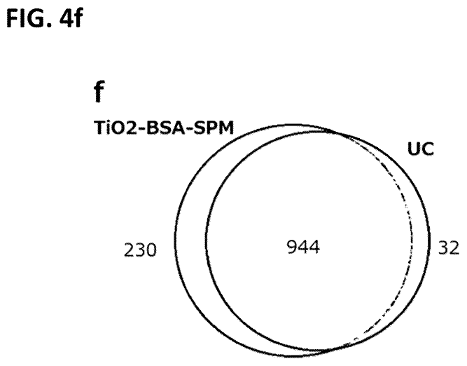

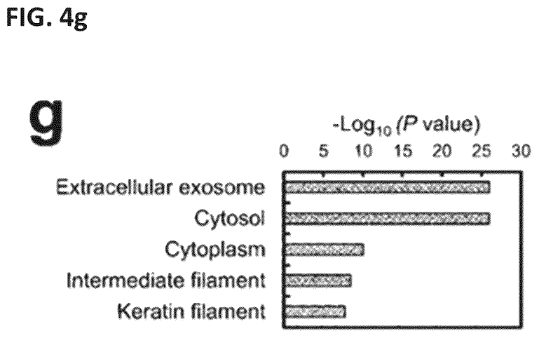

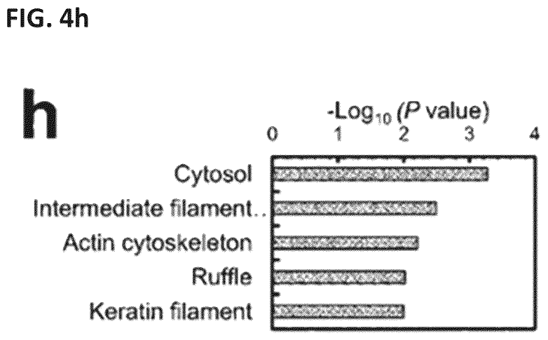

Surprisingly, the number of nanoparticles collected from 0.4 ml of culture supernatant with TIO2-BSA-SPM was higher than that collected from 38.5 mL by ultracentrifugation (FIG. 4a, left figure). Considering the loaded sample amount, the collecting efficiency of NPs with TIO2-BSA-SPM may be equivalent to 130.7 times that of UC (FIG. 4a, right figure).

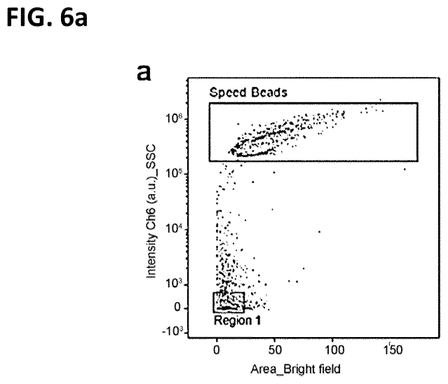

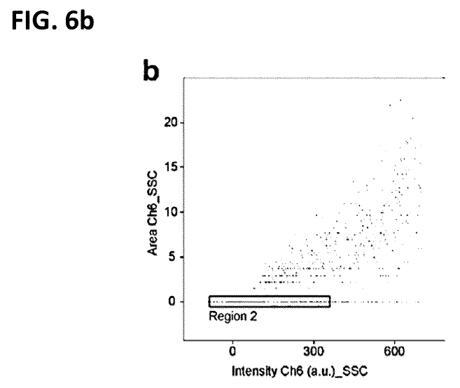

Here, the characteristics of NPs in the elution fraction of TIO2-BSA-SPM were investigated. The size of the collected NPs was determined to be almost equal to the size of those collected by UC according to NTA, and this result was confirmed by observations with an H-7650 transmission electron microscope (Hitachi, Tokyo, Japan, same hereinafter) and digital images captured using an XR-41CCCD camera system (Advanced Microscopy Techniques, Woburn, USA) (FIGS. 4b and 4c). Furthermore, the NPs collected with TIO2-BSA-SPM were fluorescently labeled by ExoSparkler® (Exosome Membrane Labeling Kit-Red, Dojindo, Kumamoto, Japan) which selectively stains lipid bilayer. Bright-field images of particles were acquired with a 40× lens in the measurements. The flow rate was set to the slowest and the lasers corresponding to fluorescence and side scatter were used at maximum power. Gating was performed to analyze single NPs (FIGS. 6a and 6b). Specifically, flow control beads were distinguished based on the side scatter light intensity and bright-field image size, and other objects were considered as particles derived from the sample. Among these, aggregates were also excluded based on scattered light intensity and image size, and the nanoparticles were analyzed for dye-derived fluorescence and scattered light. In the sample collected with TiO2-BSA-SPM, dye-stained nanoparticles were detected (FIG. 4d). Furthermore, by adding Triton-X, the number of particles for which dye fluorescence was detected was significantly reduced (FIG. 4e). The result suggested that the particles were disrupted by the addition of surfactant. These results clearly indicated that the nanoparticles collected with TiO2-BSA-SPM contained lipid bilayers.

### Example 4

### <LC-MS/MS Analysis>

A proteome analysis with LC-MS/MS was also performed to investigate the protein composition of the NPs collected with TIO2-BSA-SPM and by UC. To confirm reproducibility, three replicates were prepared by each method, and only proteins quantified in two or three replicates were certified as identified proteins. The sample amount for LC-MS/MS measurement was measured using NanoDrop (Thermo Fisher Scientific) with an absorbance at 205 nm and an extinction coefficient of 31 and standardized to 0.5 μg for each measurement. As a result, 1174 proteins were identified in the nanoparticles collected with TIO2-BSA-SPM, and 94% of Top 100 exosome marker proteins registered in Exocarta (http://exocarta.org/index.html) were included therein. 944 proteins were commonly identified in the NPs collected with TIO2-BSA-SPM and by UC, which included membrane proteins such as CD9, CD63 and CD81, and also Syntenin-1, a typical exosome marker protein (FIG. 4f). According to Gene Ontology (GO) annotation obtained from the UniProt database using David 6.8 database, 230 proteins identified only in the NPs collected with TiO2-BSA-SPM were assigned the keyword “Extracellular exosome” as a cellular component, while 32 proteins collected by UC were not assigned this keyword (FIGS. 4f, 4g and 4h). These results suggested that TIO2-BSA-SPM could collect a more diverse and highly pure population of SEVs than UC.

To verify this hypothesis, the upregulated proteins in SEVs collected with TiO2-SPM and by UC were investigated. The fold change values (FC) and P-values were calculated using the label-free quantification (LFQ) intensities by Welch's t-test. An FC>1 and P-value<0.05 were set as the criteria to select upregulated proteins. According to the GO analysis, both groups of proteins were assigned the keyword “Extracellular exosome” as a cellular component. This result indicates that the average protein composition of collected SEVs is clearly different between the two methods, supporting the possibility that some SEVs collected with TIO2-BSA-SPM might be missed by UC.

Briefly, TiO2-BSA-SPM was demonstrated to be significantly superior to UC in terms of both processing time and collection efficiency as a method for the purification of SEVs.

### Supplementary Explanation of Examples

### <Preparation of Fluorescent Liposomal Nanoparticle>

Stock solutions of lipids were mixed and homogenized at a molar ratio of 49.8% 1-palmitoyl-2-oleoyl-sn-glycero-3-phosphocholine (POPC, Tokyo Chemical Industry, Tokyo, Japan), 14.9% 1-palmitoyl-2oleoyl-sn-glycero-3-phosphoethanolamine (POPE, Tokyo Chemical Industry) and 14.9% cholesterol (Tokyo Chemical Industry), 19.9% 1-palmitoyl-2-oleoyl-sn-glycero-3-phospho-L-serine (POPS, Tokyo Chemical Industry), 0.5% 1,2-dioleoyl-sn-glycero-3-phosphoethanolamine-N-(7-nitro-2-1,3-benzoxadiazol-4-yl) (ammonium salt) (NBD-PE, Tokyo Chemical Industry) in chloroform.

<Isolation of SEVs from HEK293 by Ultracentrifugation>

The human embryonic kidney cell line HEK293T [obtained from RIKEN BRC] was cultured in Dulbecco's Modified Eagle Medium (DMEM, Thermo Fisher Scientific) containing 10% fetal bovine serum (FBS, Thermo Fisher Scientific) at 37° C. with 5% CO2. Cells were grown until approximately 70-80% confluent and then cultured in an EV-depleted medium for 48 h. SEVs were collected from the resulting culture supernatant by ultracentrifugation to reduce heterogeneity caused by their sizes. The supernatant was centrifuged at 300×g for 10 min, 2000×g for 10 min, and 10000×g for 30 min. The temperature was kept at 4° C. during centrifugation processes. After filtration with a 0.22 um membrane filter, ultracentrifugation was conducted at 120000 g for 100 min at 4° C. The SEV pellets were washed with PBS by re-centrifugation under the same conditions. Morphology observation of cells was conducted by using the all-in-one fluorescence microscope (BZ-X810, Keyence, Osaka, Japan).

### <Transmission Electron Microscopy>

SEV samples were placed on a carbon-coated grid for 10 min, followed by negative staining for 1 min after washing off the sample solution with 2% uranium acetate solution. Staining was removed with filter paper, and the grid was dried. The SEV samples were observed using an H-7650 transmission S4 electron microscope (Hitachi, Tokyo, Japan). Digital images were captured using an XR-41CCCD camera system (Advanced Microscopy Techniques, Woburn, USA).

### <Nanoparticle Tracking Analysis (NTA)>

The concentration and size distribution of EVs were measured based on Brownian motion using a NanoSight NS300 nanoparticle characterization instrument (Malvern Panalytical, Tokyo, Japan). For each acquisition, five shots of 60 s were used. The average of the 3 captures for each biological replicate was used to determine the mode of size distribution and nanoparticle concentration.

### <Single Particle Analysis of SEV Using Imaging Flow Cytometry>

The measurements were performed on an AMNIS ImageStreamX Mark II Flow Cytometer (Luminex, TX, USA). Calibration was performed before each sample measurement. The flow velocity was calibrated from the average velocity of SpeedBeads (Luminex, TX, USA) flowing in the channel. The side scattered light intensity was calibrated using the default intensity of a 785 nm laser irradiated on the SpeedBeads. Each laser intensity was calibrated by measuring the scattered light intensity when irradiated to the flowing SpeedBeads. For measurements of SEV particles, the signals were detected at Ch4 for brightfield, Ch3 for Mem Dye-Red in the SEV membrane, and Ch6 for side scatter (SSC). The laser power was maximized (561 nm: 200 mW, 642 nm: 150 mW, SSC: 70 mW). All measurements were performed at a low flow rate and 40× magnification. SEVs were measured as fluorescence-corrected samples. SEVs were corrected using TiO2-SPM and the solvent was changed to PBS by 10 kDa ultrafiltration membrane (Merck, Darmstadt, Germany). SEV solution (90 μL) was mixed with water (10 μL) and ExoSperkler Mem Dye solution (2 μL), and incubated at 37° C. for 30 min. To demonstrate the presence of lipid bilayer particles, a control sample was prepared by adding a 1% triton X-100 aqueous solution (10 μL) to the SEV solution (90 μL), and the mixture was left at room temperature for 1 h, and then the solution was reacted with ExoSperkler Mem Dye solution (2 μL). Each solution was placed in a filtration tube and washed with PBS to remove the unreacted dye compound. Analysis of the fluorescence intensity of each object was performed by IDEAS (Luminex, TX, USA).

### <Protein Digestion and Purification of Peptide Samples for LC-MS/MS Analysis>

SEVs were dried and digested utilizing the phase-transfer surfactant (PTS)-aided trypsin digestion protocol. [T. Masuda, M. Tomita, Y. Ishihama, J. Proteome Res. 2008, 7, 731.]. Proteins were reduced with 10 mM dithiothreitol (DTT) (FUJIFILM Wako Pure Chemical Corporation, Osaka, Japan) for 30 min at 37° C., followed by alkylation with 50 mM 2-iodoacetamide (IAA) (FUJIFILM Wako Pure Chemical Corporation) for 30 min at room temperature in the dark. The samples were diluted to 2 M urea with 50 mM ammonium bicarbonate. The proteins were digested with 1 μg lysyl endopeptidase (LysC) (FUJIFILM Wako Pure Chemical Corporation) and 1 μg trypsin (Promega, Tokyo, Japan) overnight at 37° C. in a shaking incubator. The resulting peptides were acidified with 0.5% trifluoroacetic acid (TFA, final concentration), and fractionated with a StageTip containing SDB-XC (upper) and SCX (bottom) Empore disk membranes (GL Sciences, Tokyo, Japan). Peptides were washed with 0.1% TFA in 5% ACN and 0.1% TFA in 80% ACN. Then, the peptides eluted from the tip by 4% TFA in 30% ACN with 500 mM ammonium acetate and 30% ACN with 500 mM ammonium acetate. The sample solution was evaporated in a SpeedVac (Thermo Fisher Scientific), and the residue was resuspended to 0.5% TFA in 5% ACN. Finally, the peptides were desalted again by StageTip with SDB-XC Empore disk membranes and suspended in the loading buffer (0.5% TFA in 5% ACN) for subsequent LC-MS/MS analyses. After digestion, peptide concentration was measured on NanoDrop (Thermo Fisher Scientific) with an absorbance at 205 nm and an extinction coefficient of 31 [R. K. Scopes, Anal. Biochem. 1974, 59, 277.]. The peptides were separated on pulled in house needle columns packed with ReproSil-Pur 120 C18-AQ 3-μm RP material (Dr. Maisch, Ammerbuch, Germany).

### <LC-MS/MS Analysis>

NanoLC-MS/MS analysis was performed using a Q-Exactive (Thermo Fisher Scientific), which was connected to an UltiMate 3000 pump (Thermo Fisher Scientific) and an HTC-PAL autosampler (CTC Analytics). Peptides were separated on house needle columns (150 mm length, 100 μm inner diameter, 6 μm needle opening) packed with ReproSil-Pur 120 C18-AQ 3-μm RP material (Dr. Maisch, Ammerbuch, Germany) [Y. Ishihama, J. Rappsilber, J. S. Andersen, M. Mann, J. Chromatogr. A 2002, 979, 233.]. The samples were applied by 5-μL full loop injection, and the flow velocity was 500 nL/min. Separation was done using a four-step linear gradient of 4 to 10% ACN for 5 min, 10 to 40% MeCN for 60 min, 40 to 99% MeCN for 10 min, and 99% MeCN for 10 min with 0.5% TFA. The electrospray voltage was set to 2.4 kV in the positive mode. The full MS scan was acquired with a mass range of 350-1500 m/z, a resolution of 70,000, an automatic gain control (AGC) target of 3e6, and a maximum injection time of 100 ms. MS/MS scan was performed by the Top 10 method with the resolution of 17,500, the AGC target of 1e5, a maximum injection time of 100 ms, and an isolation window of 2.0 Th. The precursor ions were fragmented by higher-energy collisional dissociation with a normalized collision energy of 27%.

### <Database Searching>

For all experiments, the raw MS data files were analyzed by MaxQuant/v2.0.3.0 [J. Cox, M. Mann, Nat. Biotechnol. 2008, 26, 1367.]. Peptides and proteins were identified by an automated database searching using Andromeda against the human SwissProt Database (version 2023-02, 20,588 protein entries) with a precursor mass tolerance of 20 ppm for the first search, 4.5 ppm for the main search, and a fragment ion mass tolerance of 20 ppm. The enzyme was set as Trypsin/P with two missed cleavages. Cysteine carbamidomethylation was set as a fixed modification. Methionine oxidation and acetylation on the protein N-terminus were set as variable modifications. The search results were filtered with FDR <1% at the peptide spectrum match (PSM) and protein levels. Match-between-run algorithm (MBR) was utilized via the [Identification] subtab in the [Global Parameters] tab of MaxQuant to mitigate the missing value problem. The default settings for MBR were used (0.7 min match window and 20 min alignment time), Proteins that have “Only identified by site”, “potential contaminants” and “reverse sequences” were removed for data analysis. Missing or zero values were replaced with a minimum value to evaluate relative abundance.

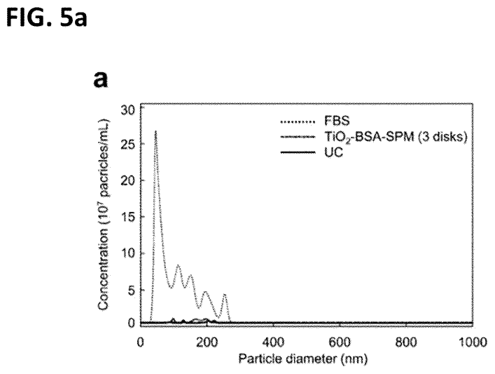

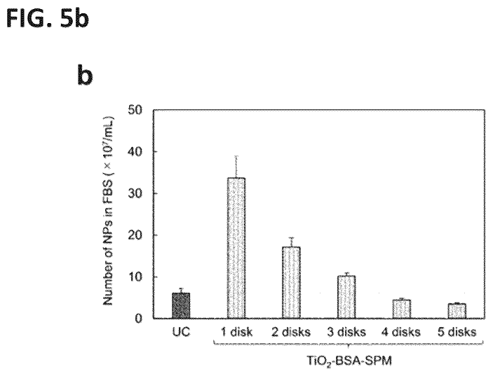

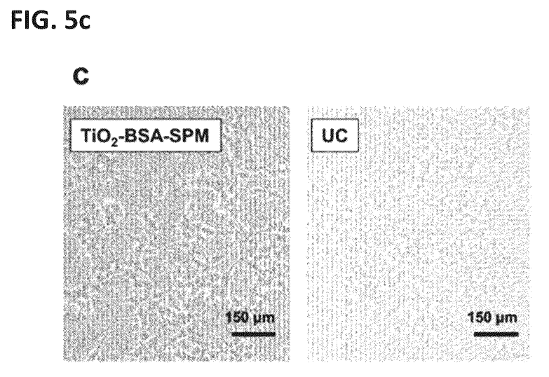

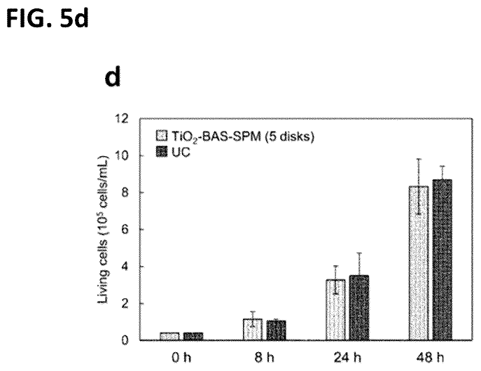

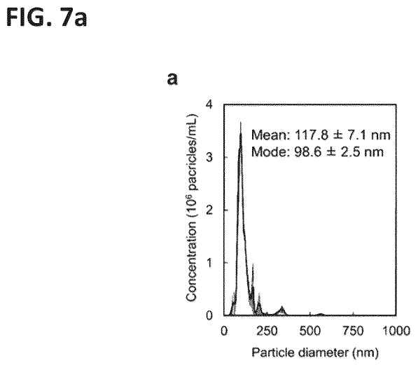

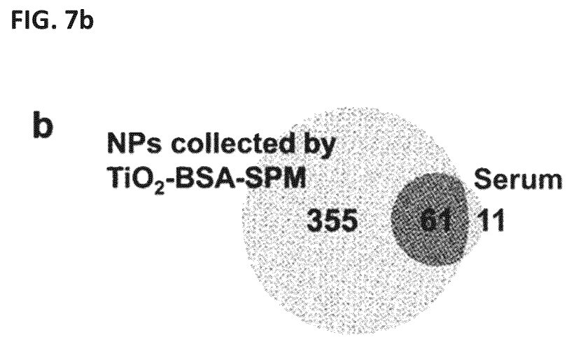

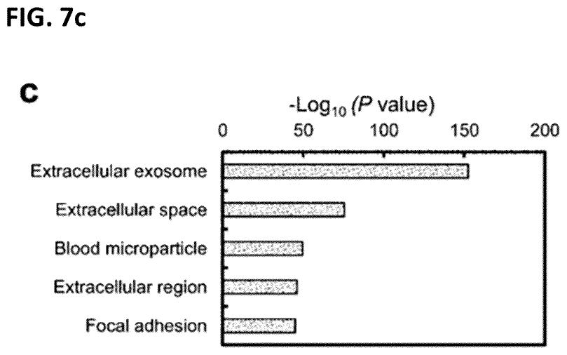

Especially, the TiO2-BSA-SPM is also highly applicable to clinical samples. The particle size and proteome profiles of NPs collected from 10 μL of serum sample from a healthy donor (CosmoBio; Human Serum (pool) Human, KOJ-12181201, BJ11104A) with TiO2-BSA-SPM were investigated. The mean size of the collected nanoparticles was found to be 117.8±7.1 nm (FIG. 7a). Furthermore, 355 proteins were identified in only NPs collected with TiO2-BSA-SPM compared to the serum sample and contained typical exosome markers (FIG. 7b). According to a GO annotation, the protein group was assigned by the keyword “Extracellular exosome” as a cellular component (FIG. 7c). The protein group was also assigned by the keyword “Blood microparticle”. Although this keyword indicates phospholipid micro-vesicles that are derived from any of several cell types, such as platelets, blood cells, and endothelial cells, SEVs could not be separated from these particles due to the characteristics of the TiO2-BSA-SPM method, especially to those of lipid bilayer membranes. This result emphasized the effectiveness and wide application of the TiO2-SPM method for SEV collection. Finally, TIO2-BSA-SPM method was applied to remove EVs from fetal bovine serum (FBS), demonstrating the high throughput and flexibility thereof. FBS contains essential proteins, lipids, and carbohydrates required for many cell cultures and is widely used as a growth factor for in vitro cell culture. However, bovine-derived EVs are present in FBS, which can increase the background of EVs in the evaluation system. UC has been commonly used to remove EVs, but it takes more than 16 h due to the low throughput of UC. To accelerate EV research, a technique for removing EVs from large volumes of FBS is necessary. Here, a syringe-barrel type solid-phase extraction cartridge was prepared as a spin column type treating only 0.5 μL of sample. The syringe-barrel type can accommodate up to 5 TiO2-BSA-SPM disks, enabling to increase the adsorption capacity. Furthermore, by setting an additional syringe as a sample reservoir at the top, up to 25 ml of sample can be processed at once. The loading process was performed by manual pressure, enabling the treatment of viscous FBS due to the large through-pores in TIO2-BSA-SPM. FIG. 2 shows the results of removing EVs from 10 ml of FBS with TIO2-BSA-SPM. TIO2-BSA-SPM treatment significantly reduced the number of nanoparticles in the FBS (FIG. 5a). Especially, using 4 or more TiO2-BSA-SPM disks resulted in higher SEV removal efficiency than UC for 16 h (FIG. 5b). To investigate the effects on cells, HEK293T cells were cultured using EV depleted FBS prepared with TiO2-BSA-SPM. The cell count over time was similar between cells cultured in EV depleted FBS prepared by UC and with TiO2-BSA-SPM, indicating that the TIO2-BSA-SPM method did not cause damage to the cells (FIGS. 5c and 5d). Briefly, TIO2-BSA-SPM was found to be able to provide a simple method for removing EVs from large volumes.

### INDUSTRIAL APPLICABILITY

The TiO2-SPM according to the present invention will be a universal platform for collecting and purifying SEVs and significantly contribute to drug discovery research and biomarker exploration using SEVs.

What is claimed is:

1. A porous monolithic polymer for separation and purification of biological particles, obtained by hybridization of an olefin-based thermoplastic resin and an inorganic oxide.

2. The porous monolithic polymer for separation and purification of biological particles according to claim 1, wherein the thermoplastic resin is one or more selected from the group consisting of poly(ethylene-co-glycidyl methacrylate) (PEGM), ethylene-vinyl acetate copolymer, high-density polyethylene, low-density polyethylene, olefin-based elastomer, and polyamide-based elastomer.

3. The porous monolithic polymer for separation and purification of biological particles according to claim 1, wherein the inorganic oxide is one or more selected from the group consisting of titanium oxide, magnesium oxide, aluminum oxide, silicon dioxide, and calcium phosphate.

4. The porous monolithic polymer for separation and purification of biological particles according to claim 1, wherein a porosity is 50% to 90%, a pore size is 1 μm to 200 μm, and a melting point is 60° C. to 180° C.

5. A method for production of the porous monolithic polymer for separation and purification of biological particles according to claim 1, comprising:
melting the thermoplastic resin;
kneading the inorganic oxide into the thermoplastic resin together with a pore template and an auxiliary of pore template; and
eluting the pore template with an aqueous solvent after molding.

6. The method for production according to claim 5, wherein the pore template is an organic substance or an inorganic substance which does not react with the thermoplastic resin and the inorganic oxide during the kneading.

7. The method for production according to the claim 6, wherein the pore template is one or more selected from the group consisting of pentaerythritol, corn starch, sodium sulfate anhydrous, starch such as wheat starch and potato starch, artificial sweeteners such as aspartame and saccharin, polysaccharide such as hemicellulose, acid-soluble inorganic compounds such as calcium carbonate and magnesium carbonate, and salt.

8. The method for production according to claim 5, wherein the pore template has a particle size between 1 μm to 200 μm.

9. The method for production according to claim 5, wherein the auxiliary of pore template is a monomer or polymer of polyhydric alcohol.

10. The method for production according to claim 9, wherein the auxiliary of pore template is one or more selected from the group consisting of polyalkylene glycol and diethylene glycol, such as (poly(oxyethylene-oxypropylene)) triol and polyethylene glycol.

11. A method for separation and purification of biological particles having phospholipid on the surface by the porous monolithic polymer for separation and purification of biological particles according to claim 1.

12. The method according to claim 11, wherein the biological particles are extracellular vesicles.
